(19) United States
(12) Patent Application Publication
(10) Pub. No.: US 2006/0033736 A1
(43) Pub. Date: Feb. 16, 2006

(54) Enhanced Color and Lighting Model for Computer Graphics Productions

(76) Inventor: Andy W. Wang, Sherman Oaks, CA (US)

Correspondence Address: LAW OFFICE OF KARRY W. WANG, 3342 PARK RIDGE DR, RICHMOND, CA, 94806, US

(21) Appl. No.: 11/161,641

(22) Filed: Aug. 10, 2005

Related U.S. Application Data
(60) Provisional application No. 60/600,037, filed on Aug. 10, 2004.

(51) Int. Cl. G06T 15/50; G06T 15/60

(52) U.S. Cl. 345/426

(57) ABSTRACT

A color and lighting method and model for computer graphics productions that automates most of the lighting and compositing processes, creates a light rig that works for at least most of the shots in a given sequence, and allows multiple shots to be run simultaneously without manual interaction.

### CROSS-REFERENCE TO RELATED APPLICATIONS

This application claims the benefit of U.S. Provisional Application No. 60/600,037 filed on Aug. 10, 2004, the content of which is expressly incorporated herein by reference in its entirety.

### FIELD OF THE INVENTION

The present invention relates generally to computer graphics productions and, more particularly, to color and lighting models within a computer graphics production.

### BACKGROUND OF THE INVENTION

Computer graphics (CG) has become an important, if not an integral, part of today's filmmaking process. For example, performances that cannot be or are too dangerous to be accomplished by human actors or stunt doubles are made possible by using CG visual effects. Similarly, CG effects can make fairytale characters and imaginary worlds seem realistic. In fact, it has been said that CG or, more specifically, three-dimensional CG (3D-CG) has made everything possible in a visual production and is only limited by one's imagination.

In the animation genre of filmmaking, 3D-CG has prevailingly overtaken the traditional 2D cell animation. In general, a CG production crew goes through the following six steps to produce colored images:

1) Shot Directory Setup

A “shot” is a segment of a film, normally from the time the camera starts to roll until it is “cut” to set up another camera angle. In this first step, a shot structure is created and generic environment files (e.g., files that are required to have a working digital directory to properly run a shot) are copied over. This step is very mechanical and is the same for every shot.

2) Generate Geometry

Before an image can be generated by 3D-CG, the mathematical representation of the 3D geometric models need to be created that represent the objects being rendered into the image. Most studios have their own file format; some pre-bake (i.e., pre-generate) their geometry files, and some evaluate them on-the-fly as the image is being rendered. Whatever the case may be, the process is the same for every shot. The only difference is the digital source file that is used to determine the particular geometry that is present in the scene.

3) Generate Lighting Files

The term “lighting”, sometimes referred to as “color and lighting”, in a CG production generally means the positioning of CG lights in a CG scene, together with 3D geometry, materials and shaders, to render out colored images (generally called CGI, or computer generated imagery).

This step includes generating digital files that contain information about the CG lights, materials and shaders for the geometry from Step 2, the relationships between the lights and the geometry, and any other information that is necessary to produce the final colored images. This is perhaps the most labor intensive step of a CG pipeline.

4) Rendering Images

Rendering is the process that generates a two-dimensional image, or series of images, from a specific view of a three-dimensional scene. In this step, the digital files created in step 3 are sent to a computer or computers equipped with rendering software to render out images.

5) Compositing

In most film productions, a CG scene is rendered out in different layers of images, e.g., foreground and background images. Compositing is a process in which these layers of images are put together in the order that is meant to be seen by the camera, so that one piece of geometry appears to be in front of, or behind, another. Often, there are color corrections, pixel manipulations, and other operations performed on the different layers of images to give the desired effect(s).

In this process, one or more compositing scripts are generated to composite the images rendered from Step 4. A “script” as used herein means a set of computer programming commands written in a text format.

6) Make Movie Files for the Shots

Most film studios now make compressed movie files for every shot. This process strings together all the composite images from Step 5 in a compressed format to facilitate playing back the shot at real time. Normally, the movie files also contain audio information.

The above six steps are repeated for every shot, and usually for numerous times, to produce the final desired images. As stated, creating the lighting files in Step 3 above is often the most time-consuming and requires the most hands-on work in a lighting/compositing pipeline. This is because the lighting artists need to place the CG lights for each shot in such a way that, in addition to creating a desired look for a particular shot, all related shots appear homogenous so that the transition from one shot to another would appear seamless.

Normally, a film is strategically broken down into different sequences to facilitate the production. Shots for each sequence are normally taken from the same location and, thus, contain similar contents.

Most studios have adopted a method in which one or a few shots are selected as key shots for a given sequence. Before the lighting production of the sequence begins, digital lighting files for the key shots are generated first by more experienced artists. Once completed and approved, the key shots are used as visual references for the remaining shots of the sequence. In other words, the lighting files (i.e., light rigs) from the key shots are commonly used as a starting point for the less experienced lighting artists to generate the lighting for their shots.

The problem with this method is that propagating light rigs from key shots often does not work. This is because a key shot does not reveal everything that is in the sequence. Thus, the CG lights that are set up to work locally for the key shot do not necessarily cover everything in the whole sequence. Other times, the lights set up to work for a particular camera angle may not work as well for shots that have the camera looking from another angle. This problem is especially prevalent when the CG environment is big.

When a light rig that does not work is propagated, it often creates more problems for the artists instead of saving time. Because most artists work differently and think differently, it is often difficult for one artist to decipher another artist's set up to make the lights work for a different shot. Ironically, when this happens, it is often faster and better for the second artist to start from scratch and just match visually to the approved key shots rather than using a light rig.

Even when using a light rig that, to a certain degree, works, the resulting first take (i.e., the first time a particular shot is run) is often still very far off from the desired finished look.

Therefore, there is a need for a more efficient lighting/compositing pipeline that would eliminate the flaws of the current use of light rigs and the repetitive manual labor in the six general steps discussed above.

### BRIEF DESCRIPTION OF THE DRAWINGS

The foregoing and other objects, aspects and advantages will be better understood from the following description of a preferred embodiment in accordance with the present invention with reference to the accompanying drawings, in which like numerals reference like elements, and wherein:

FIG. 1 is a diagram in accordance with the present invention;

FIG. 2 is a diagram of an embodiment of the present invention;

FIG. 3 is a diagram of an embodiment of the present invention.

### SUMMARY OF THE INVENTION

It is an object of the present invention to provide a lighting/compositing pipeline that automates most of the shot setup process that is normally done by hand.

It is another object of the subject invention to provide a lighting model that can be used to setup light rigs that work for most of the shots in a sequence.

It is a further object of the present invention to provide an automated lighting and compositing pipeline that allows multiple shots to be run simultaneously without manually opening up any interactive lighting or compositing tools, and the number of shots that can be run simultaneously is only limited by the power of the computers dedicated to rendering images (e.g., a rendering farm).

It is still another object of the present invention to provide an automated lighting and compositing pipeline that allows an artist to take on several shots at a time without much additional stress.

It is still a further object of the subject invention to provide a lighting model that can produce first takes that are 70 to 90 percent complete from the finished look.

### DETAILED DESCRIPTION OF THE INVENTION

The present invention is directed to methods and systems for creating a more efficient lighting and compositing pipeline for a CG production.

In recent years, ambient occlusion, i.e., exposure mapping, has become increasingly more popular in the world of three-dimensional computer graphics (3D-CG). Ambient occlusion is a technique that imitates the ambient, or non-directional, lighting where the surfaces in a 3D-CG world are uniformly illuminated by a theoretical hemisphere, or dome, that encloses this 3D-CG world. The uniform lighting that hits each surface in the 3D-CG world is occluded, or attenuated, by the proximity of other surfaces.

The result of using ambient occlusion is that the images created contain natural-looking soft shadows where the corners of a room, for instance, are gradually darker than the floor or the ceiling near the center of the room. In other words, the computer graphics (CG) images produced by using ambient occlusion emulate those in the real world.

Ambient occlusion is widely applied by baking (pre-calculating) the exposure maps directly into the texture maps (i.e., the maps that provide the basic color and texture information for a given surface in 3D-CG) of the surfaces of the CG objects. This is often done by pre-multiplying the values in the texture maps by the values in the exposure maps. The result is that for areas where an exposure map is bright (e.g., close to 1), the returned value for the texture map is close to its original value. For the parts where the exposure map is dark (e.g., close to 0), the returned value for the texture map is dimmed, which simulates shadows. This is not very flexible because whenever the surfaces are illuminated, the effect of ambient occlusion is already there. Some dark corners or niches may never be illuminated bright enough for the artistic needs of the picture.

A lighting model in accordance with the present invention, however, puts an “ON/OFF” switch for the exposure maps into CG lights instead of “baking” them directly into the texture maps. By doing so, it gives an artist the flexibility to turn the effect of the exposure maps on and off at will. Thus, the exposure maps are applied only when desired. For example, if a place is too dim in the scene, an artist can easily use a light that is not attenuated by the exposure maps to illuminate where more light is needed.

When ambient occlusion is used with “non-shadowing” directional lights, it becomes a great way to produce fill lights (as opposed to a “key” light, or a “rim” light) without conflicting shadows, while retaining the flexibility of directing the lighting.

More specifically, the present invention teaches a lighting model that can be applied to any CG environment once the ambient occlusion data are calculated for every surface in the CG environment.

In a preferred embodiment, this is done by first defining a 3D-CG environment that encloses all objects of interest (e.g., all objects in a sequence). The ambient occlusion data are calculated for the objects, and a computer software is used to calculate the center point of this 3D-CG environment.

Using ambient occlusion with directional lights, which is discussed in further detail below, the 3D-CG environment can be easily lit by flooding it with lights from all directions without creating conflicting shadows. For mathematical simplicity, an imaginary cube can be calculated to enclose the environment. Using this imaginary lighting cube, lights from “all directions” into the environment can thus be simplified down to 6 directions (i.e., the 6 directions orthogonal to the 6 sides of a cube) as shown in FIG. 1.

A software can be written to calculate the center point of any 3D-CG environment and create a “bounding box” that encloses the environment. This bounding box can be used as the lighting cube described above.

Still referring to FIG. 1, the designation of the order of the directions is random and is only used for demonstration purposes. For most shot sequences, one CG light per direction is sufficient. This results in 6 fill lights, the positions of which can be calculated automatically by software by using the bounding box and its center point.

Preferably, at least 1 of the lights has the ambient occlusion turned “ON”. More preferably, 5 of the 6 lights are ambient occluded, non-shadowing directional lights. Most preferably, 4 of the 6 lights are ambient occluded, non-shadowing directional lights. The remaining 2 lights are preferably non-shadowing, traditional lights (CG lights with intensities that are not affected by the exposure maps).

Not all 6 fill lights are ambient occluded because when all lights are attenuated by exposure maps, some surfaces that are very close together may not receive enough light and would render almost black. Examples of such surfaces include those inside a character's mouth, the bottom of a plate sitting on top of a table, etc. The non-ambient occluded fill lights (e.g., 2 non-ambient occluded fill lights in the most preferred embodiment) should have low intensities to give some light to those surfaces that have very close proximities to one another. Often, but not always, the 2 regular fill lights come from the top and bottom directions (e.g., directions 5 and 6) of the lighting cube. The positions of the 6 lights are preferably calculated by computer software and are further discussed in Example 1 below.

In addition to the 6 fill lights, an additional light is preferably used as a key light. This seventh light should be a shadowing, traditional directional light and can come from any direction, depending on the various artistic requirements of a particular sequence and the style of the artist. The intensity of each fill light can, of course, be controlled individually to compliment the key light to produce a realistic sense of light direction in the 3D-CG world.

The main advantage of a light model in accordance with the present invention is that the basis of the lighting work can be automated. Because the positions of the 6 fill lights and other default parameters such as the number and direction of non-ambient occluded lights and their default intensities can be preset and calculated by computer software, all that is required of the artist(s) is to position the key light and to balance the intensities of all 7 lights.

The lighting model disclosed herein provides a solid foundation for lighting in any 3D-CG environment, and can be used as the basis for a lighting rig. The lighting rig, however, should be tested in a “location shot” before propagating to other shots. A location shot, as used herein, is not a real shot in the production, but a shot that contains geometry of all objects in a particular sequence. It also contains a fly-through CG camera that covers all camera angles in that sequence.

By rendering out this location shot as seen by the fly-through camera, and compositing the images via the fly-through camera, an artist can check how well the basis of the light rig works for every shot in the sequence. In other words, a light rig is tested as the CG camera “flies” through the entire 3D-CG environment. Modifications to the parameters of the lights, if needed, can then be appropriately made. The location shot should be used as a place to thoroughly test the light rig to ensure that it will serve most or all of the shots in the sequence well.

This is a vast improvement of the traditional way of setting up light rigs from key shots, which cannot ensure that the light rigs will work for other shots in the sequence.

Thus, the present invention eliminates the shortcomings of the current use of key shots and light rigs generated by the key shots.

### EXAMPLE 1

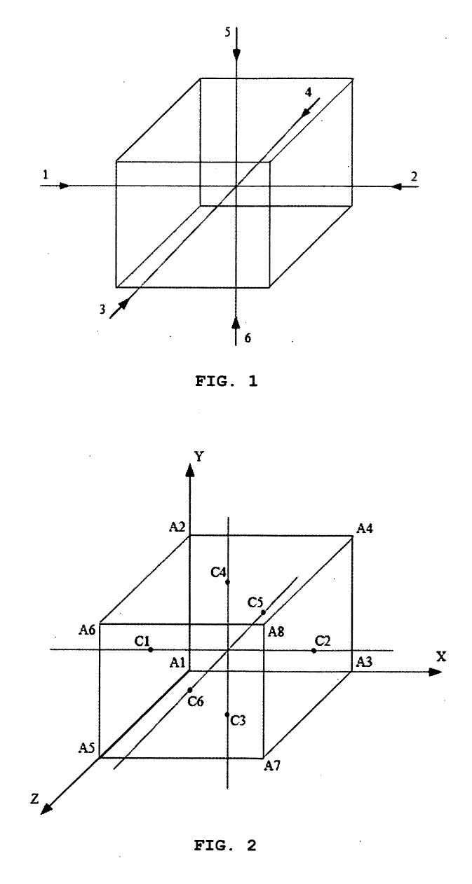

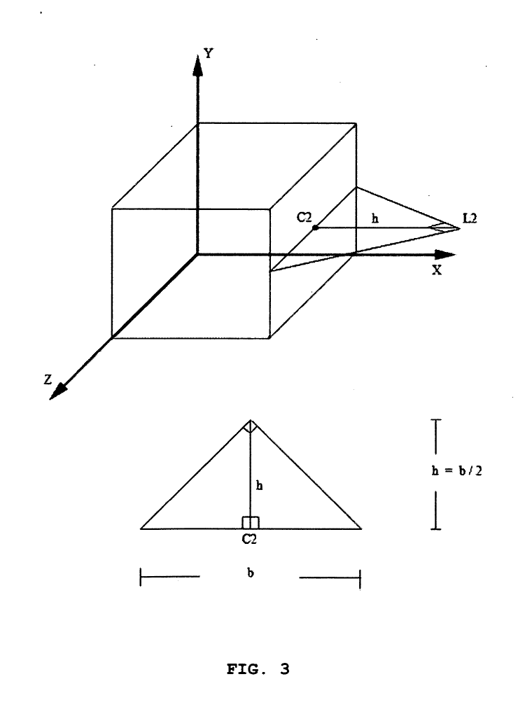

Referring now to FIG. 2, in the case of a 3D-CG environment in which the sides of its bounding box or lighting cube are parallel to the 3 axes X, Y and Z, the mathematics and the coordinates of the 8 corners of the bounding box and the center of each of the box's 6 surfaces can be designated and calculated as follows:

The maximum and minimum values of the X, Y, and Z axes are denoted as Xmax, Xmin, Ymax, Ymin, Zmax, Zmin, respectively.

Thus, the coordinates of the 8 corners of the bounding box (randomly designated as A1-A8) are:

A1 (Xmin, Ymin, Zmin); A2 (Xmin, Ymax, Zmin);

A3 (Xmax, Ymin, Zmin); A4 (Xmax, Ymax, Zmin);

A5 (Xmin, Ymin, Zmax); A6 (Xmin, Ymax, Zmax);

A7 (Xmax, Ymin, Zmax); and A8 (Xmax, Ymax, Zmax).

The 6 surface centers C1-C6 are:

C1 (Xmin, (Ymin+Ymax)/2, (Zmin+Zmax)/2);

C2 (Xmax, (Ymin+Ymax)/2, (Zmin+Zmax)/2);

C3 ((Xmin+Xmax)/2, Ymin, (Zmin+Zmax)/2);

C4 ((Xmin+Xmax)/2, Ymax, (Zmin+Zmax)/2);

C5 ((Xmin+Xmax)/2, (Ymin+Y max)/2, Zmin); and

C6 ((Xmin+Xmax)/2, (Ymin+Ymax)/2, Zmin).

The positions of the 6 fill lights L1-L6 can be:

L1 (Xmin−(Zmax−Zmin)/2, (Ymin+Ymax)/2, (Zmin+Zmax)/2);

L2 (Xmax+(Zmax−Zmin)/2, (Ymin+Ymax)/2, (Zmin+Zmax)/2);

L3 ((Xmin+Xmax)/2, Ymin−(Xmax−Xmin)/2, (Zmin+Zmax)/2);

L4 ((Xmin+Xmax)/2, Ymax+(Xmax−Xmin)/2, (Zmin+Zmax)/2);

L5 ((Xmin+Xmax)/2, (Ymin+Ymax)/2, Zmin−(Xmax−Xmin)/2);

L6 ((Xmin+Xmax)/2, (Ymin+Ymax)/2, Zmax+(Xmax−Xmin)/2).

The position of each of the 6 fill lights are calculated by simple geometry. Each light is a standard 90-degree cone light. Each light can be seen as to form a 90-degree isosceles triangular cone with the surface that it faces towards. Using Light L2 as an example and turning to FIG. 3:

Distance “b”=Zmax−Zmin, then,

Distance “h”=(Zmax−Zmin)/2

Since C2 is (Xmax, (Ymin+Ymax)/2, (Zmin+Zmax)/2),

L2 is (Xmax+(Zmax−Zmin)/2, (Ymin+Ymax)/2, (Zmin+Zmax)/2).

In addition to the lighting cube, a lighting and compositing pipeline in accordance with the present invention also uses a wrapping script (e.g., a set of computer programming commands written in a text format) to automate the 6 steps for producing colored images as summarized in the Background section. In other words, because <step 3: generate lighting files> can be automated by the lighting model described above, <Step 5: Compositing> can be done with pre-generated scripts, and because all other steps are the same for every shot, a wrapping script can be written to call forth the relevant files and pre-generated scripts. All an artist has to do is to input into the wrapping script which shot or shots to run and which lighting or compositing files to load in. Therefore, all 6 steps can be run in batch mode on a computer without any hands-on, interactive work.

Although the invention herein has been described with reference to particular embodiments, it is to be understood that the embodiments are merely illustrative of the principles and application of the present invention. It is therefore to be understood that various modifications may be made to the above mentioned embodiments and that other arrangements may be devised without departing from the spirit and scope of the present invention as defined by the appended claims.

For example, although fill lights from 6 directions are preferred, as described above, fill lights from as few as 3 directions may work sufficiently well because a camera can never see more than 3 sides of an object in a 3D environment. In addition, more than 1 light per direction or other variations can be used in the embodiments described above. Similarly, more than 1 key light may be used in more complicated or larger CG environments. Thus, more or fewer lights and lighting directions can be incorporated based on specific artistic directions to build upon the basic lighting model described above without departing from the spirit and scope of the present invention.

Furthermore, in accordance with the instant invention and contrary to traditional teachings, not all of the 6 steps for producing CG images would need to be repeated for every single take. For example, after running the first take, the shot directory would not have to be created again. Similarly, if the lighting file works, but the compositing file needs to be modified to change the order of the rendered elements, only Step 5 and Step 6 need to be repeated. As such, a pipeline in accordance with the subject invention provides an efficient way to repeat any number of the process steps for any given number of shots.

What is claimed is:

1. A method for creating a light rig for a CG production, comprising:
defining a 3D-CG environment for a sequence;
creating a location shot containing geometry of all objects within the 3D-CG environment and a fly-through CG camera that covers all camera angles of the sequence;
creating the light rig by flooding sufficient light into the 3D-CG environment with CG lights;
testing the light rig by rendering images via the fly-through CG camera; and
optionally modifying the CG lights and re-rendering the images via the fly-through CG camera at least once.

2. The method of claim 1, wherein CG lights from at least 3 directions with respect to the 3D-CG environment are used in the step of creating the light rig, and wherein at least 1 CG light is used per direction.

3. The method of claim 2, wherein CG lights from at least 6 directions are used in the step of creating the light rig, and wherein the at least 6 directions are top, bottom, front, rear, left and right directions, and every direction is orthogonal to the plane of a different face of an imaginary cube having 6 orthogonal faces.

4. The method of claim 3, wherein all lights are ambient occluded, non-shadowing directional lights.

5. The method of claim 3, wherein at least 1 light is non-ambient occluded, non-shadowing, traditional light.

6. The method of claim 5, wherein at least 1 additional light from a seventh direction is used as a key light, and wherein the at least 1 additional light is a shadowing, traditional directional light.

7. The method of claim 6, wherein the step of optionally modifying the CG lights comprises one member selected from the group consisting of changing the direction of at least one CG light, balancing the intensities of the CG lights, and modifying at least one parameter of one CG light.

8. A lighting model for a CG production, comprising:
sufficient CG lights to properly illuminate all surfaces seen by a rendering CG camera within a 3D-CG environment,
wherein at least one CG light is ambient occluded.

9. The lighting model of claim 8, wherein the sufficient lights illuminate the surfaces from at least 3 directions, and wherein at least 1 CG light is used per direction.

10. The lighting model of claim 9, wherein the sufficient lights illuminate the surfaces from at least 6 directions, and wherein the 6 directions are top, bottom, front, rear, left and right directions, and every direction is orthogonal to the plane of a different face of an imaginary cube having 6 orthogonal faces.

11. The lighting model of claim 10, wherein all lights are ambient occluded, non-shadowing directional lights.

12. The lighting model of claim 10, wherein at least 1 light is non-ambient occluded, non-shadowing, traditional light.

13. The lighting model of claim 12, further comprising at least 1 additional light from a seventh direction, wherein the at least 1 additional light is a shadowing, traditional directional light.

14. A method for creating a lighting and compositing pipeline for a CG production capable of running a plurality of shots simultaneously, comprising the steps of:
A) setting up shot directories;
B) generating geometry of CG objects;
C) providing a means for creating a light rig;
D) rendering CG images via a shot camera;
E) compositing rendered CG images;
F) making movie files for a sequence,
wherein at least one of the steps is accomplished by at least one computer script or program.

15. The method of claim 14, wherein Step C) further comprises:
C1) defining a 3D-CG environment for a sequence;
C2) creating a location shot containing geometry of all objects within the 3D-CG environment and a fly-through CG camera that covers all camera angles of the sequence;
C3) creating the light rig by flooding sufficient light into the 3D-CG environment with CG lights;
C4) testing the light rig by rendering images via the fly-through CG camera; and
C5) optionally modifying the CG lights and re-rendering the images via the fly-through CG camera at least once.

16. The method of claim 15, further comprising the step of providing a wrapping script to call forth the at least one computer script or program as needed.

17. The method of claim 16, wherein CG lights from at least 3 directions with respect to the 3D-CG environment are used in the step of creating the light rig, and wherein at least 1 CG light is used per direction.

18. The method of claim 17, wherein CG lights from at least 6 directions are used in the step of creating the light rig, and wherein the 6 directions are top, bottom, front, rear, left and right directions, and every direction is orthogonal to the plane of a different face of an imaginary cube having 6 orthogonal faces, and wherein at least 1 light is ambient occluded.

19. The method of claim 18, wherein at least 1 additional light from a seventh direction is used as a key light, and wherein the at least 1 additional light is a shadowing, traditional directional light.

20. The method of claim 15, wherein the step of testing the light rig includes compositing the rendered images.
